(19) United States
(12) Patent Application Publication
(10) Pub. No.: US 2019/0294429 A1
(43) Pub. Date: Sep. 26, 2019

(54) ON-BOARD UPDATE SYSTEM, ON-BOARD UPDATE APPARATUS, ON-BOARD DEVICE, AND UPDATE METHOD

(71) Applicants: AutoNetworks Technologies, Ltd., Yokkaichi-shi , Mie (JP); Sumitomo Wiring Systems, Ltd., Yokkaichi-shi , Mie (JP); Sumitomo Electric Industries, Ltd., Osaka-shi (JP)

(72) Inventors: Tomohiro Mizutani, Yokkaichi-shi, Mie (JP); Masayuki Inoue, Yokkaichi-shi, Mie (JP); Hiroshi Tateishi, Yokkaichi-shi, Mie (JP); Makoto Saburi, Yokkaichi-shi, Mie (JP)

(21) Appl. No.: 16/339,318

(22) PCT Filed: Sep. 20, 2017
(86) PCT No.: PCT/JP2017/033794

§ 371 Date: Apr. 3, 2019

(30) Foreign Application Priority Data
Oct. 4, 2016 (JP) 2016-196558

(51) Int. Cl. G06F 8/65; G07C 9/00; G06F 9/445; H04L 29/08; H04W 4/44; G06K 9/00

(52) U.S. Cl. CPC G06F 8/65; G07C 9/00896; G06F 9/445; G06K 9/00791; H04W 4/44; G06K 9/00255; G06K 9/00288; H04L 67/34

(57) ABSTRACT

Provided are an on-board update system, an on-board update apparatus, an on-board device, and an update method, updates the on-board device without limiting the use of the vehicle for the convenience of the user. An on-board update system for updating a program or data stored in a storage unit of an on-board device transmits an update program or data stored in an update storage unit to the on-board device, and interrupts the transmission of the update program or data to the on-board device depending on the circumstances around a vehicle. The on-board device includes, in its storage unit, a first storage region in which a pre-update program or data is stored and a second storage region configured to store an update program or data. The on-board device restores the execution of the pre-update program or data if the transmission of the update program or data is interrupted.

### CROSS-REFERENCE TO RELATED APPLICATIONS

This application is the U.S. national stage of PCT/JP2017/033794 filed Sep. 20, 2017, which claims priority of Japanese Patent Application No. JP 2016-196558 filed Oct. 4, 2016, the contents of which are incorporated herein.

### TECHNICAL FIELD

The present disclosure relates to an on-board update system, an on-board update apparatus, an on-board device, and an update method, for updating programs or data in on-board devices installed in a vehicle.

### BACKGROUND

A vehicle is conventionally equipped with a plurality of communication apparatuses such as ECUs (Electronic Control Units), which are connected via communication lines such as CAN (Controller Area Network) buses and thereby capable of transmitting and receiving information to and from each other. In each ECU that performs various processes such as the control of a vehicle, a processor including a CPU (Central Processing Unit) reads out and executes a program stored in a storage unit such as a flash memory or EEPROM (Electrically Erasable Programmable Read Only Memory). The program or data stored in the storage unit of each ECU needs to be updated with a new program or data, for example, when required to add a function, to correct a fault, to upgrade, etc. In this case, an update program or data is transmitted via a communication line to the ECU to be updated.

In a program update system proposed by JP 2015-103163A, update data for a control apparatus to be updated contain not only an update control program for the control apparatus but also a computer program that enables means for calculating a digest value relating to the update control program, means for deciding whether the updated control apparatus operates normally, and means for returning the result of the decision. The control apparatus to be updated receives the update data, and updates the control program with the update control program contained in the received update data. Then, the control apparatus executes the computer program and decides whether the updated control apparatus operates normally, thus being capable of checking the validity of the program update.

While a program or data stored in the storage unit of one of the ECUs is being updated, this ECU cannot perform its usual process until the update process is completed. As a result, the vehicle is unavailable until an update process in the ECU is completed. There is a possibility that the vehicle cannot be used due to the update process in the ECU, for example, when a user urgently needs to use the vehicle. This may limit the use of the vehicle and cause inconvenience to the user.

An object of the present disclosure, made in view of such circumstances, is to provide an on-board update system, an on-board update apparatus, an on-board device, and an update method, each of which enables an update process in an on-board device installed in a vehicle, without limiting the use of the vehicle for the convenience of the user.

### SUMMARY

An on-board update system according to one aspect of the present disclosure is an on-board update system configured to update a program or data stored in a storage unit of an on-board device that is installed in a vehicle and includes the storage unit, which is configured to store the program or data, and a processing unit, which is configured to read out and execute the program or data stored in the storage unit, the on-board update system including: an update storage unit configured to store an update program or data; an update information transmission unit configured to transmit the update program or data stored in the update storage unit to the on-board device; and an interruption unit configured to interrupt the transmission of the update program or data by the update information transmission unit to the on-board device. The storage unit of the on-board device includes a first storage region in which a program or data being executed by the processing unit is stored and a second storage region configured to store the update program or data. The on-board device includes an update information receiving unit configured to receive the update program or data transmitted by the update information transmission unit, an update information writing unit configured, if the update information receiving unit receives the update program or data, to stop the execution of the program or data stored in the first storage region by the processing unit, and to write the update program or data received by the update information receiving unit into the second storage region, a restoring unit configured to restore the execution of the program or data stored in the first storage region by the processing unit if the interruption unit interrupts the transmission, and an updating unit configured, after the writing of the update program or data into the second storage region is completed, to change a program or data to be executed by the processing unit from the program or data stored in the first storage region to the program or data stored in the second storage region.

Also, the interruption unit of the on-board update system according to one aspect of the present disclosure may interrupt the transmission of the update program or data depending on the circumstances around the vehicle.

The interruption unit of the on-board update system according to one aspect of the present disclosure may interrupt the transmission of the update program or data if a user of the vehicle is present around the vehicle.

The on-board update system according to one aspect of the present disclosure may further include a wireless communication unit configured to perform wireless communication with a portable communication device, and the interruption unit may interrupt the transmission of the update program or data depending on a result of communication with the communication device by the wireless communication unit.

The on-board update system according to the present disclosure may further include a distance determination unit configured to determine the distance to the communication device depending on a result of communication with the communication device by the wireless communication unit, and the interruption unit may interrupt the transmission if the distance determined by the distance determination unit is shorter than a predetermined distance.

The on-board update system according to one aspect of the present disclosure may further include a wireless communication apparatus that includes the wireless communication unit, the distance determination unit, and a distance determination result transmission unit configured to transmit a determination result by the distance determination unit, and an on-board update apparatus that includes the update storage unit, an update information acquisition unit configured to acquire an update program or data from an apparatus outside the vehicle and to store the acquired update program or data to the update storage unit, a distance determination result receiving unit configured to receive a determination result transmitted by the distance determination result transmission unit of the wireless communication apparatus, and the interruption unit.

The on-board update system according to one aspect of the present disclosure may further include a wireless communication apparatus that includes the wireless communication unit and a communication result transmission unit configured to transmit a result of communication with the communication device by the wireless communication unit, and an on-board update apparatus that includes the update storage unit, an update information acquisition unit configured to acquire an update program or data from an apparatus outside the vehicle and to store the acquired update program or data to the update storage unit, a communication result receiving unit configured to receive a communication result transmitted by the communication result transmission unit of the wireless communication apparatus, the distance determination unit, and the interruption unit.

The on-board update system according to one aspect of the present disclosure may further include an on-board update apparatus that includes the wireless communication unit, the distance determination unit, the update storage unit, an update information acquisition unit configured to acquire an update program or data from an apparatus outside the vehicle and to store the acquired update program or data to the update storage unit, and the interruption unit.

The on-board update system according to one aspect of the present disclosure may further include a camera configured to capture the surroundings of the vehicle, and the interruption unit may interrupt the transmission of the update program or data depending on a capturing result of the camera.

The on-board update system according to one aspect of the present disclosure may further include a biological information acquisition unit configured to acquire biological information of a person, and the interruption unit may interrupt the transmission of the update program or data depending on the biological information acquired by the biological information acquisition unit.

An on-board update apparatus according to one aspect of the present disclosure is an on-board update apparatus configured to update a program or data stored in a storage unit of an on-board device that is installed in a vehicle and includes the storage unit, which is configured to store the program or data, and a processing unit, which is configured to read out and execute the program or data stored in the storage unit, the on-board update apparatus including: an update information acquisition unit configured to acquire an update program or data from an apparatus outside the vehicle; an update storage unit configured to store the update program or data acquired by the update information acquisition unit; an update information transmission unit configured to transmit the update program or data stored in the update storage unit to the on-board device; and an interruption unit configured to interrupt the transmission of the update program or data by the update information transmission unit to the on-board device.

An on-board device according to one aspect of the present disclosure is an on-board device that is installed in a vehicle and includes a storage unit, which is configured to store a program or data, and a processing unit, which is configured to read out and execute the program or data stored in the storage unit, the storage unit includes a first storage region in which a program or data being executed by the processing unit is stored and a second storage region configured to store an update program or data, and the on-board device includes: an update information receiving unit configured to receive an update program or data; an update information writing unit configured, if the update information receiving unit receives the update program or data, to stop the execution of the program or data stored in the first storage region by the processing unit, and to write the update program or data received by the update information receiving unit into the second storage region; a restoring unit configured to restore the execution of the program or data stored in the first storage region by the processing unit if the transmission of the update program or data is interrupted; and an updating unit configured, after the writing of the update program or data to the second storage region is completed, to change a program or data to be executed by the processing unit from the program or data stored in the first storage region to the program or data stored in the second storage region.

An update method according to one aspect of the present disclosure is an update method for updating a program or data stored in a storage unit of an on-board device that is installed in a vehicle and has the storage unit, which is configured to store the program or data, and a processing unit, which is configured to read out and execute the program or the data stored in the storage unit, the storage unit of the on-board device includes a first storage region in which a program or data being executed by the processing unit is stored and a second storage region configured to store an update program or data, the update method includes the steps of transmitting the update program or data stored in an update storage unit to the on-board device; interrupting the transmission of the update program or data to the on-board device depending on the circumstances around the vehicle; the on-board device, if the update program or data is received, stopping the execution of the program or data stored in the first storage region by the processing unit, and writing the received update program or data to the second storage region; the on-board device restoring the execution of the program or data stored in the first storage region by the processing unit if the transmission of the update program or data is interrupted; and the on-board device, after the writing of the update program or data to the second storage region is completed, changing a program or data to be executed by the processing unit from the program or data stored in the first storage region to the program or data stored in the second storage region.

According to one aspect of the present disclosure, an update program or data stored in the update storage unit is transmitted to the on-board device, and the update process is performed by the on-board device writing the received update program or data into its own storage unit. Note, that the on-board device has, in its storage unit, the first storage region that stores the program or data being executed at that time (a pre-update program or data) and the second storage region into which an update program or data is written. The on-board device writes the received update program or data into the second storage region in its storage unit without overwriting the program or data stored in the first storage region. The on-board device that has written the update program or data updates the program or data by changing the program or data to be executed from the program or data stored in the first storage region to the program or data stored in the second storage region. Note, that after completion of the update process, the relationship between the first storage region and the second storage region in the storage unit of the on-board device is reversed. Accordingly, in the next update process, the region in which the update program or data was written in the previous update process is the first storage region.

Furthermore, according to one aspect of the present disclosure, it is possible to interrupt the transmission of an update program or data to the on-board device. If the transmission of the update program or data is interrupted, the on-board device interrupts the writing to the second storage region, and restores the execution of the program or data stored in the first storage region. By enabling to interrupt the update process of the on-board device and to return to the operation performed before the update, the user can use the vehicle during the update process.

According to one aspect of the present disclosure, the transmission of an update program or data is interrupted depending on the circumstances around the vehicle. A configuration can be employed, for example, in which the transmission is interrupted if the user of the vehicle is present around the vehicle. With this configuration, it is possible to interrupt the update process if there is a possibility that the vehicle will be used.

According to one aspect of the present disclosure, wireless communication with a portable communication device owned by the user or the like of the vehicle is performed, and the transmission of an update program or data to the on-board device is interrupted depending on the communication result. The portable communication device may be, for example, a wireless key for remotely operating the door lock of the vehicle. Depending on the result of communication with the wireless key, it is possible to presume whether there is a possibility that the user will use the vehicle. By enabling to interrupt the update process of the on-board device depending on the result of communication with the portable communication device and to return to the operation performed before the update, the user can use the vehicle during the update process.

According to one aspect of the present disclosure, depending on the result of communication with the portable communication device, the distance to the communication device can be determined. The distance can be estimated, for example, depending on the signal strength of the radio signal transmitted from the communication device, and it is possible to determine whether the distance is shorter or longer than the predetermined distance. If the distance to the communication device is shorter than the predetermined distance, it can be presumed that the user who has this communication device is present near the vehicle and there is a high possibility that the user will use the vehicle. By interrupting the update process of the on-board device in such a case, the user can smoothly start running the vehicle when the user intends to drive the vehicle.

Also, according to one aspect of the present disclosure, the wireless communication apparatus that performs wireless communication with the portable communication device determines the distance based on the communication result and transmits the determination result, and the on-board update apparatus that stores and transmits an update program or data receives the determination result from the wireless communication apparatus and performs interruption processing.

Alternatively, according to one aspect of the present disclosure, the wireless communication apparatus that performs wireless communication with the portable communication device transmits the communication result, and the on-board update apparatus that stores and transmits an update program or data determines the distance based on the communication result from the wireless communication apparatus and performs interruption processing.

With these configurations, it is possible to interrupt the update process of the on-board device by the cooperation of the wireless communication apparatus and the on-board update apparatus.

Also, according to one aspect of the present disclosure, the function for performing wireless communication with the portable communication device is provided on the on-board update apparatus that stores and transmits an update program or data, and the on-board update apparatus determines the distance based on the result of communication with the portable communication device and performs interruption processing. In this manner, a configuration may be employed in which one apparatus performs wireless communication with the portable communication device and the transmission of an update program or data to the on-board device.

According to one aspect of the present disclosure, a camera captures the surroundings of the vehicle, and the transmission of an update program or data is interrupted depending on the capturing result. A configuration can be employed, for example, in which a face of a person is detected from the image captured by the camera, and the transmission of the update program or data is interrupted if a face is detected. Furthermore, a configuration can be employed in which face authentication for determining whether the detected face matches the face registered as the user of the vehicle is performed, and the transmission of an update program or data is interrupted according to the authentication result. With these configurations, it is possible to interrupt an update process if the user who may use the vehicle is present around the vehicle.

According to one aspect of the present disclosure, biological information of a person is acquired, and the transmission of an update program or data is interrupted according to the acquired biological information. In the system that can acquire biological information including fingerprint information or vein information of the user of the vehicle, perform an authentication process for fingerprint authentication, vein authentication, or the like, and perform the unlocking of the door, the start of the engine, or the like of the vehicle only if the authentication succeeds, a configuration can be employed in which an update process is interrupted if the authentication succeeds. With this configuration, it is possible to interrupt an update process if a possibility that the user will use the vehicle is high.

### Advantageous Effects of Disclosure

The present disclosure enables the user to use the vehicle during an update process, by employing a configuration in which the update process of the on-board device is interrupted and the on-board device can return to the operation performed by a pre-update program or data, and the on-board device can be updated without limiting the use of the vehicle for the convenience of the user.

### BRIEF DESCRIPTION OF DRAWINGS

FIG. 1 is a schematic diagram showing the configuration of an on-board update system according to the present embodiment.

FIG. 2 is a block diagram showing the configuration of an ECU.

FIG. 3 is a schematic diagram illustrating an update process performed by the ECU.

FIG. 4 is a block diagram showing the configuration of a gateway.

FIG. 5 is a block diagram showing the configuration of a BCM.

FIG. 6 is a flowchart showing a procedure of an update program acquisition process performed by the gateway.

FIG. 7 is a flowchart showing a procedure of an update program transmission process performed by a server apparatus.

FIG. 8 is a flowchart showing a procedure of an update process performed by the gateway.

FIG. 9 is a flowchart showing a procedure of processes performed by the BCM.

FIG. 10 is a flowchart showing a procedure of an update process performed by the ECU.

FIG. 11 is a block diagram showing the configuration of a BCM according to a second embodiment.

FIG. 12 is a block diagram showing the configuration of a gateway according to the second embodiment.

FIG. 13 is a block diagram showing the configuration of a gateway according to a third embodiment.

FIG. 14 is a schematic diagram showing the configuration of an on-board update system according to a fourth embodiment.

FIG. 15 is a block diagram showing the configuration of a gateway according to the fourth embodiment.

FIG. 16 is a schematic diagram showing the configuration of an on-board update system according to a fifth embodiment.

### DETAILED DESCRIPTION OF PREFERRED EMBODIMENTS

### First Embodiment

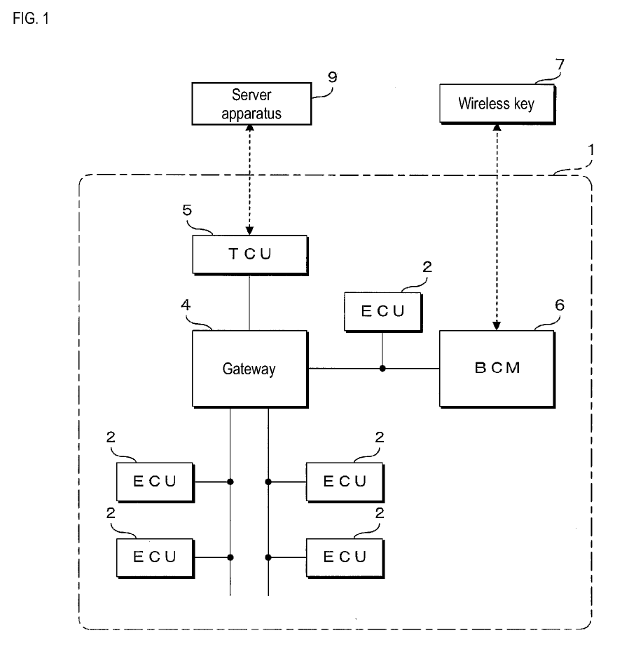

FIG. 1 is a schematic diagram showing the configuration of an on-board update system according to the present embodiment. The on-board update system according to the present embodiment is a system in which a plurality of apparatuses such as ECUs 2 (Electronic Control Units) and a BCM 6 (Body Control Module) installed in a vehicle 1 communicate with each other via communication lines and a gateway 4 arranged in the vehicle 1. In the on-board update system according to the present embodiment, the ECUs 2 correspond to on-board devices to be updated, the gateway 4 corresponds to an on-board update apparatus that transmits an update program or data, and the BCM 6 corresponds to a wireless communication apparatus that performs wireless communication with a wireless key 7 that corresponds to a portable communication device. Also, in the on-board update system according to the present disclosure, a TCU (Telematics Communication Unit) 5 is connected to the gateway 4 via the communication line, and the gateway 4 can communicate with a server apparatus 9 installed outside of the vehicle 1 via the TCU 5.

The ECUs 2 may include various ECUs such as an ECU for controlling the operation of the engine, an ECU for controlling the operation of the air bags, and an ECU for controlling the operation of the ABS (Antilock Brake System) of the vehicle 1. Each ECU 2 is connected to the communication lines arranged in the vehicle 1, and can transmit and receive data to and from other ECUs 2, the gateway 4, and the BCM 6 via the communication lines. Each ECU 2 performs a designated process by reading out and executing a program or data stored in its internal storage unit. The program or data stored in each ECU 2 may be updated, for example, for adding a function or correcting a problem.

The plurality of communication lines constituting an in-vehicle network of the vehicle 1 are connected to the gateway 4, and the gateway 4 relays transmission and reception of data between the communication lines. In the example shown in FIG. 1, four communication lines are connected to the gateway 4. By transmitting data received from one of the communication lines to another communication line, the gateway 4 relays the data.

The TCU 5 can transmit and receive data to and from the server apparatus 9, for example, by performing wireless communication using a mobile telephone communication network. The TCU 5 is connected to the gateway 4 via the communication line arranged in the vehicle 1, and can transmit and receive data to and from the gateway 4 through wired communication. In this manner, the TCU 5 can relay the communication performed between the gateway 4 and the server apparatus 9, transmits data provided from the gateway 4 to the server apparatus 9, and provides data received from the server apparatus 9 to the gateway 4.

The server apparatus 9 manages and stores programs and data executed by the ECUs 2 that are installed in the vehicle 1. In response to an inquiry from the vehicle 1, the server apparatus 9 notifies whether an update of the program or the like is necessary, and delivers an update program or data to the vehicle 1 if an update is necessary.

The BCM 6 is an apparatus that controls, for example, the locking/unlocking of the doors, turning on/off lighting, and the operation of the wiper of the vehicle 1. The BCM 6 has a function for performing wireless communication with the portable wireless key 7, and controls the locking/unlocking of the doors according to the result of communication with the wireless key 7, for example. The BCM 6 according to the present embodiment has a function for calculating the distance to the wireless key 7, for example, based on the reception strength of a radio signal transmitted from the wireless key 7. The BCM 6 transmits, to the gateway 4, the information of the calculated distance to the wireless key 7 via the communication line in the vehicle 1.

Also, the gateway 4 according to the present embodiment performs, for example, communication with the server apparatus 9 via the TCU 5 while the vehicle 1 is driving, and acquires an update program or data necessary for an update process of the ECU 2 from the server apparatus 9 and stores the acquired update program or data in the gateway 4. The gateway 4 transmits the stored update program or data to the ECU 2 to be updated, for example, if a predetermined update condition, such as reaching a predetermined time, is satisfied after the vehicle 1 was stopped, and updates the program or data stored in the storage unit of the ECU 2. Also, at least while the update process is being performed, the gateway 4 acquires the information of the distance to the wireless key 7, which is calculated by the BCM 6, and interrupts the update process of the ECU 2 if the wireless key 7 is present near the vehicle 1 (if the distance to the wireless key 7 is shorter than a predetermined distance). If the update process is interrupted, the ECU 2 returns to the operation performed by the pre-update program or data.

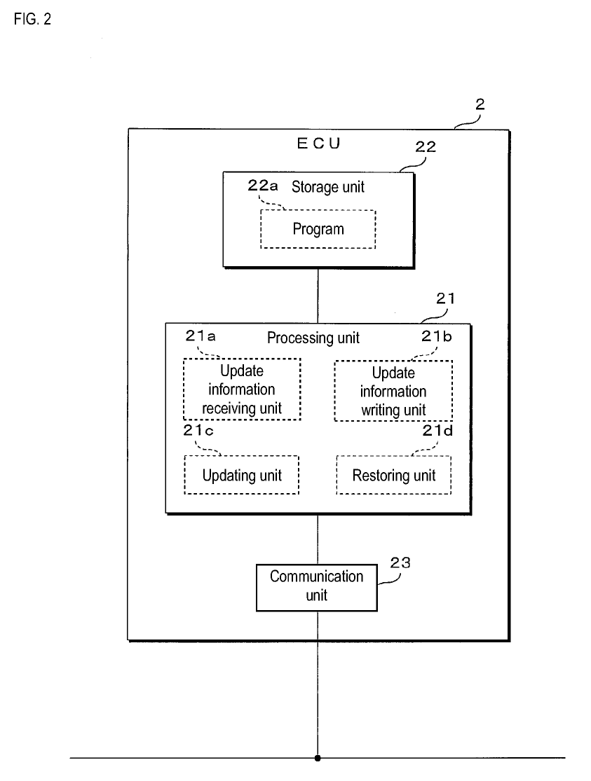

FIG. 2 is a block diagram showing the configuration of the ECU 2. This diagram focuses on the functional blocks that all of the plurality of ECUs 2 have, and omits the functional blocks that are different in each ECU 2. Each of the ECUs 2 according to the present embodiment includes a processing unit 21, a storage unit 22, and a communication unit 23. The processing unit 21 is constituted, for example, by a computation processing unit such as a CPU (Central Processing Unit) or an MPU (Micro-Processing Unit). The processing unit 21 performs various computations by reading out and executing a program 22a stored in the storage unit 22. The program 22a stored in the storage unit 22 is different in each ECU 2.

The storage unit 22 is configured using a non-volatile memory device such as a flash memory or EEPROM (Electrically Erasable Programmable Read

Only Memory). The storage unit 22 stores not only the program 22a to be executed by the processing unit 21 but also data necessary for executing the program 22a. Hereinafter, the term “program 22a” may encompass the program 22a and the data necessary for executing the program 22a.

The communication unit 23 is connected to the communication line that constitutes the in-vehicle network, and transmits and receives data in accordance with, for example, a communication protocol such as CAN (Controller Area Network). To transmit data, the communication unit 23 converts the data provided from the processing unit 21 into an electric signal, and outputs the electric signal to the communication line. To receive data, the communication unit 23 samples the electrical potential at the communication line, and provides the received data to the processing unit 21.

The processing unit 21 of each ECU 2 according to the present embodiment includes an update information receiving unit 21a, an update information writing unit 21b, an updating unit 21c, and a restoring unit 21d. The update information receiving unit 21a to the restoring unit 21d are functional blocks for updating the program 22a stored in the storage unit 22. The update information receiving unit 21a to the restoring unit 21d are software-like functional blocks that are enabled when the processing unit 21 executes a program (illustration omitted) different from the program 22a to be updated.

The update information receiving unit 21a receives an update program transmitted from the gateway 4 and received by the communication unit 23 via the communication line, and accumulates the received update program in a buffer memory or the like (illustration omitted). The update program accumulated in the update information receiving unit 21a is written in a free space on the storage unit 22 by the update information writing unit 21b. After the update information writing unit 21b has finished writing the update program, the update processing unit 21c invalidates the pre-update program stored in the storage unit 22 and validates the newly-written update program, thereby updating the program 22a. If the transmission of the update program from the gateway 4 is interrupted, the restoring unit 21d restores the operation in the pre-update state by starting a process on the pre-update program stored in the storage unit 22.

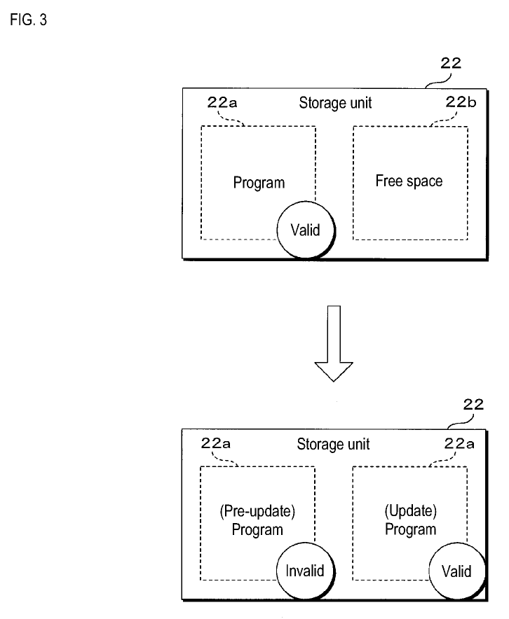

FIG. 3 is a schematic diagram illustrating an update process performed by the ECU 2. The storage unit 22 of the ECU 2 according to the present embodiment has a storage capacity sufficient for at least two sets of the program 22a. In the example shown in the upper part of FIG. 3, the storage unit 22 includes the program 22a and a free space 22b having a capacity that is substantially equal to the size of the program 22a. In this state, the program 22a stored in the storage unit 22 is valid, and the processing unit 21 reads out and executes this program 22a.

If the update information receiving unit 21a receives an update program from the gateway 4, the update information writing unit 21b stores the received update program 22a in the free space 22b on the storage unit 22 without overwriting the pre-update program 22a. After the update information writing unit 21b has successfully written the update program 22a in the storage unit 22 without an error, the updating unit 21c invalidates the pre-update program 22a and validates the newly-stored update program 22a, thereby completing the update process. Thereafter, the processing unit 21 in the ECU 2 reads out and executes the validated update program 22a. The invalidated pre-update program 22a may be deleted, for example, at a suitable timing. Alternatively, the invalidated pre-update program 22a may be kept in the storage unit 22 without being deleted and, for example, may be regarded as the free space 22b in the next update process.

In the ECU 2 according to this embodiment, the storage unit 22 at least includes a region for storing the pre-update program 22a (the first region) and a region for storing the update program 22a (the second region). That is to say, the storage unit of each ECU 2 has a storage region that is capable of storing at least two sets of programs 22a. The ECU 2 receives the update program 22a transmitted from the gateway 4 for an update process, and stores the received update program 22a in the region different from the region that stores the pre-update program 22a. Thus, the ECU 2 stores the update program 22a in the storage unit 22 without overwriting the pre-update program 22a. After storing the update program 22a in the storage unit 22, the ECU 2 invalidates the pre-update program 22a and validates the update program 22a, thereby effecting a changeover in the program 22a to be executed by the processing unit 21. That is to say, the ECU 2 completes the update process by a changeover in the program to be booted by the processing unit 21.

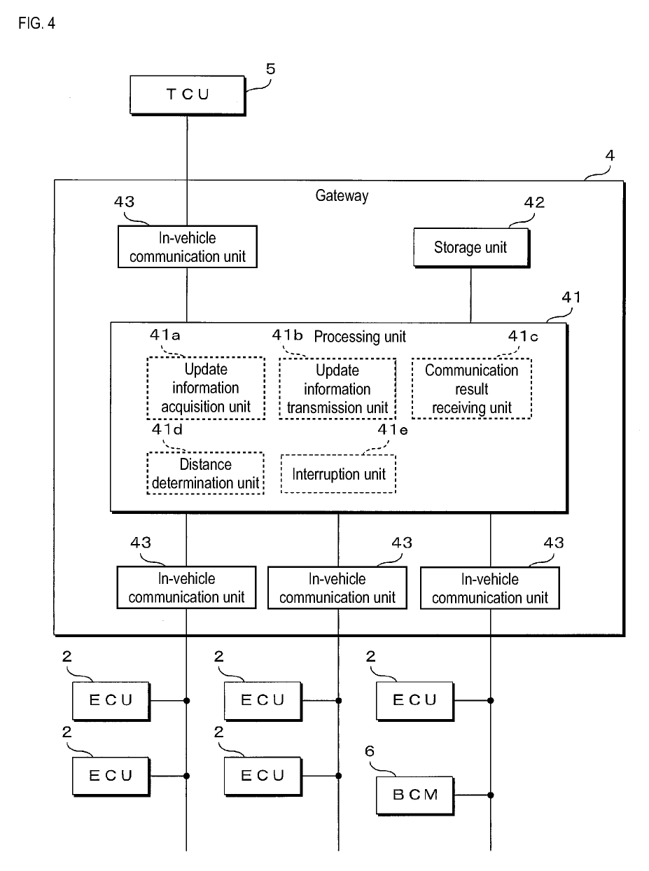

FIG. 4 is a block diagram showing the configuration of the gateway 4. The gateway 4 according to the present embodiment includes a processing unit 41, a storage unit 42, and four in-vehicle communication units 43. The processing unit 41 is configured, for example, by a computation processing unit such as a CPU or an MPU. The processing unit 41 performs various computations by reading out and executing a program stored in the storage unit 42, ROM (Read Only Memory) (not shown), or the like. In the present embodiment, the processing unit 41 relays the data transmitted and received on the communication lines that constitute the in-vehicle network, and performs computations necessary for the update processes of the ECUs 2 or for other purposes.

The storage unit 42 is configured using a non-volatile memory device such as a flash memory or EEPROM. The storage unit 42 stores, for example, programs executed by the processing unit 41 and data necessary for executing these programs Also, the storage unit 42 stores programs for updating the ECUs 2. The storage unit 42 may also store data generated during the processing by the processing unit 41.

The in-vehicle communication units 43 are respectively connected to the communication lines that constitute the in-vehicle network, and transmit and receive data in accordance with, for example, a communication protocol such as CAN. To transmit information, the in-vehicle communication unit 43 converts the data provided from the processing unit 41 into an electric signal, and outputs the electric signal to the communication line. To receive data, the in-vehicle communication unit 43 samples the electrical potential at the communication line, and provides the received data to the processing unit 41. Each of the four in-vehicle communication units 43 provided in the gateway 4 may follow different communication protocols.

The processing unit 41 executes the programs stored in the storage unit 42, ROM, or the like, and thereby enables software-like functional blocks such as an update information acquisition unit 41a, an update information transmission unit 41b, a communication result receiving unit 41c, a distance determination unit 41d, and an interruption unit 41e. The update information acquisition unit 41a performs communication with the server apparatus 9 via the TCU 5 at a predetermined timing, and inquires whether the programs 22a in the ECUs 2 installed in the vehicle 1 need updating. The predetermined inquiry timing of the necessity of updates may be a prescribed cycle (e.g., every day or every week) or, for example, every time the IG switch of the vehicle 1 is turned from off to on. When informed by the server apparatus 9 that one or more updates are necessary, the update information acquisition unit 41a acquires one or more programs, data, etc. necessary for the updates (hereinafter simply called “update program(s)”) from the server apparatus 9 via the TCU 5, and stores the update programs in the storage unit 42. The update information acquisition unit 41a acquires update programs for all of the ECUs 2 that need updating.

The update information transmission unit 41b reads out the update program acquired from the server apparatus 9 and stored in the storage unit 42 at a predetermined timing, and transmits the read-out update program to the ECU 2 to be updated. The predetermined timing for transmitting the update program may be, for example, a timing at which the IG switch of the vehicle is turned off and a predetermined time such as 2 a.m. is reached, may be timing immediately after the IG switch is turned off, or may be another timing. If the plurality of ECUs 2 need to be updated, the update information transmission unit 41b transmits update programs in an appropriate order, and transmits the update programs to all of the ECUs 2 to be updated. The ECU 2 that receives the update program from the gateway 4 writes the received update program in the free space 22b of the storage unit 22.

The communication result receiving unit 41c receives information of a result of communication with the wireless key 7 from the BCM 6 through the in-vehicle communication unit 43 connected to the in-vehicle network. The BCM 6 according to the present embodiment has a function for transmitting and receiving a radio signal to and from the wireless key 7 and for detecting the signal strength of the radio signal received from the wireless key 7, and transmits a message including the information of the detected signal strength to the gateway 4. The communication result receiving unit 41c that receives this message provides the information of the signal strength of the radio signal received from the wireless key 7 to the distance determination unit 41d.

The distance determination unit 41d determines whether the signal strength of the radio signal received from the wireless key 7 exceeds a predetermined strength based on the information that the communication result receiving unit 41c receives from the BCM 6, and determines whether the wireless key 7 is present within a predetermined distance from the vehicle 1. The distance determination unit 41d provides, to the interruption unit 41e, the determination result as to whether the wireless key 7 is present within the predetermined distance from the vehicle 1.

The interruption unit 41e interrupts the transmission of the update program to the ECU 2 by the update information transmission unit 41b according to the determination result by the distance determination unit 41d, and interrupts the update process of the program 22a of the ECU 2. That is, if it is determined that the wireless key 7 is present within the predetermined distance from the vehicle 1, the interruption unit 41e interrupts the transmission of the update program to the ECU 2 by the update information transmission unit 41b. Also, at this time, the interruption unit 41e may also notify the ECU 2 of the interruption of the update process. The ECU 2 whose update process is interrupted returns to the operation performed by the pre-update program 22a by the restoring unit 21d.

Note, that after the update process of the ECU 2 is interrupted by the interruption unit 41e, if the distance determination unit 41d determines that the wireless key 7 is not present within the predetermined distance from the vehicle 1, the interruption unit 41e may release (cancel) the interruption of the update process. If the interruption is released, the update information transmission unit 41b may resume the transmission of the update program. Note, that if the transmission of the update program is resumed, the update information transmission unit 41b may also resume the transmission from the interrupted portion, or may also retransmit the interrupted update program from the beginning. The timing at which the update program is resumed may also be, for example, a timing immediately after it is determined that the wireless key 7 is not present within the predetermined distance from the vehicle 1, or may also be a timing at which it is determined that the wireless key 7 is not present within the predetermined distance from the vehicle 1 and a predetermined condition is satisfied, such as the condition that a predetermined time has elapsed after that determination is made.

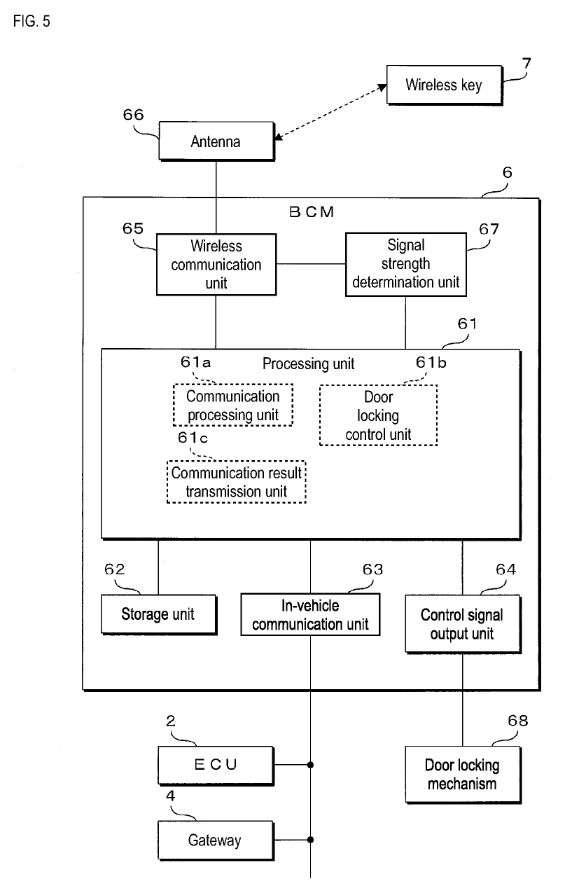

FIG. 5 is a block diagram showing the configuration of the ECU 6. The BCM 6 according to the present embodiment includes a processing unit 61, a storage unit 62, an in-vehicle communication unit 63, a control signal output unit 64, a wireless communication unit 65, and a signal strength determination unit 67. The processing unit 61 is configured, for example, with a computation processing unit such as a CPU or an MPU. The processing unit 61 performs various computations by reading out and executing programs stored in the storage unit 62, ROM (not shown), or the like. The processing unit 61 according to the present embodiment performs a process for performing wireless communication with the wireless key 7, a process for controlling the locking/unlocking of the doors of the vehicle 1 according to the result of the wireless communication, a process for notifying the gateway 4 of the signal strength of the radio signal received from the wireless key 7, and the like.

The storage unit 62 is configured using a non-volatile memory device such as a flash memory or EEPROM. The storage unit 62 stores, for example, programs executed by the processing unit 61 and data necessary for executing these programs, and may also store data generated during the process of the processing unit 61. The in-vehicle communication unit 63 is connected to the communication line that constitutes the in-vehicle network, and transmits and receives data in accordance with, for example, a communication protocol such as CAN. To transmit information, the in-vehicle communication unit 63 converts the data provided from the processing unit 61 into an electric signal, and outputs the electric signal to the communication line. To receive data, the in-vehicle communication unit 63 samples the electrical potential at the communication line, and provides the received data to the processing unit 61.

The control signal output unit 64 is connected to door locking mechanisms 68 provided in each of the doors of the vehicle 1 via control signal lines. The control signal output unit 64 outputs a control signal for controlling the operation of each of the door locking mechanisms 68 based on the process of the processing unit 61. Each door locking mechanism 68 includes a mechanical mechanism for locking/unlocking the corresponding door of the vehicle 1 and a motor or an actuator for operating this mechanical mechanism, and locks and unlocks the door according to the control signal provided from the BCM 6.

The wireless communication unit 65 is connected to an antenna 66 that is arranged at an appropriate position in the vehicle 1 and performs wireless communication with the wireless key 7 by transmitting and receiving radio signals via the antenna 66. Note, that the antennas 66 may also be separately provided for transmitting and for receiving. The wireless communication unit 65 transmits a message to the wireless key 7 by outputting a signal obtained by modulating the transmission message to the antenna 66, demodulates the signal received by the antenna 66, and acquires the message from the wireless key 7. The wireless communication unit 65 transmits the message provided from the processing unit 61 to the wireless key 7, and provides the message received from the wireless key 7 to the processing unit 61.

The signal strength determination unit 67 determines the signal strength of a radio signal, and has a function of so-called RSSI (Received Signal Strength Indication). The signal strength determination unit 67 determines the signal strength of the radio signal received by the wireless communication unit 65 from the wireless key 7, and provides the determination result to the processing unit 61.

The processing unit 61 executes the programs stored in the storage unit 62, ROM, or the like, and thereby enables software-like functional blocks such as a communication processing unit 61a, a door locking control unit 61b, and a communication result transmission unit 61c. The communication processing unit 61a performs processes related to wireless communication performed with the wireless key 7. The communication processing unit 61a according to the present embodiment periodically transmits a predetermined radio signal to the wireless key 7 even if the IG switch of the vehicle 1 is off. If the wireless key 7 receives the predetermined radio signal from the vehicle 1, the wireless key 7 responds. If the communication processing unit 61a receives a response from the wireless key 7 to the predetermined radio signal, the communication processing unit 61a performs necessary information exchange with the wireless key 7 by wireless communication, performs an authentication process and the like, for example, and determines whether the wireless key 7 is valid. If wireless communication with the valid wireless key 7 is established, the communication processing unit 61a notifies the door locking control unit 61b of the fact.

The door locking control unit 61b controls the locking/unlocking of the door of the vehicle 1 by the door locking mechanism 68 according to the result of communication with the wireless key 7 by the communication processing unit 61a. The door locking control unit 61b unlocks, for example, the door if wireless communication with the valid wireless key 7 is established, and locks the door if wireless communication with the valid wireless key 7 fails to be established. The door locking control unit 61b provides a command for locking/unlocking the door to the control signal output unit 64, and the control signal output unit 64 generates and outputs a control signal to the door locking mechanism 68 according to this command.

Every time wireless communication with the wireless key 7 is performed in the wireless communication unit 65, the communication result transmission unit 61c transmits the information of the result of the wireless communication with the wireless key 7, in the present embodiment, transmits the information of the signal strength of the radio signal from the wireless key 7 that is determined by the signal strength determination unit 67 to the gateway 4.

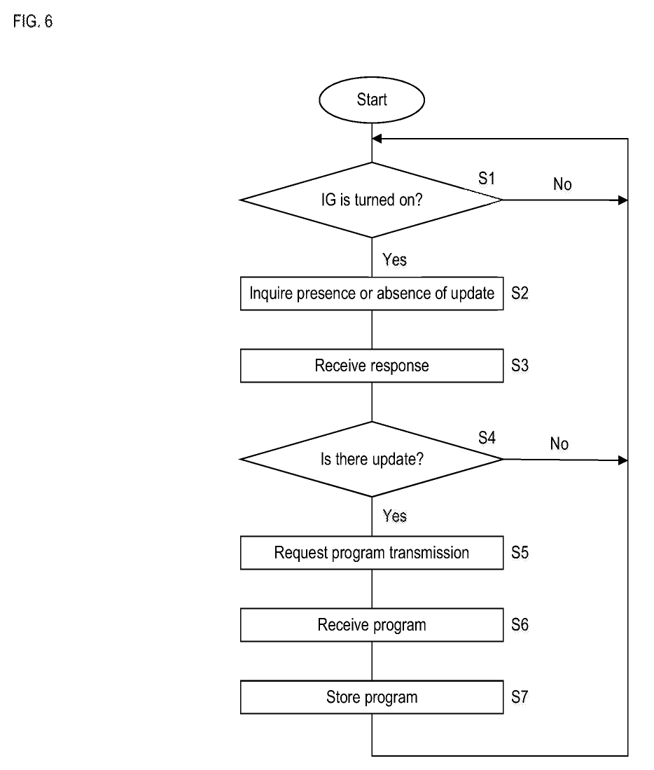

FIG. 6 is a flowchart showing a procedure of an update program acquisition process performed by the gateway 4. The update information acquisition unit 41a of the processing unit 41 of the gateway 4 determines whether the IG switch of the vehicle 1 has been turned from the off state to the on state (step S1). If the IG switch has not been turned to the on state (NO in step S1), the update information acquisition unit 41a waits until the IG switch is turned to the on state. If the IG switch has been turned to the on state (YES in step S1), the update information acquisition unit 41a performs wireless communication with the TCU 5, and inquires the server apparatus 9 installed in the vehicle 1 about the presence or absence of the updates of the programs of the ECUs 2 (step S2).

The update information acquisition unit 41a receives a response transmitted from the server apparatus 9 in response to the inquiry via the TCU 5 (step S3). In addition to the presence or absence of the update, this response includes the information on a program that needs to be updated, for example, information such as program identification information and data amount. The update information acquisition unit 41a determines the presence or absence of the updates of the programs of the ECUs 2 installed in the vehicle 1 according to the response from the server apparatus 9 (step S4). If there is no update (NO in step S4), the update information acquisition unit 41a returns the process to step S1. If there is an update (YES in step S4), the update information acquisition unit 41a requests the server apparatus 9 to transmit an update program (step S5). The update information acquisition unit 41a receives, via the TCU 5, the update program that is transmitted from the server apparatus 9 according to the request (step S6), stores the received update program to the storage unit 12 (step S7), and returns the process to step S1.

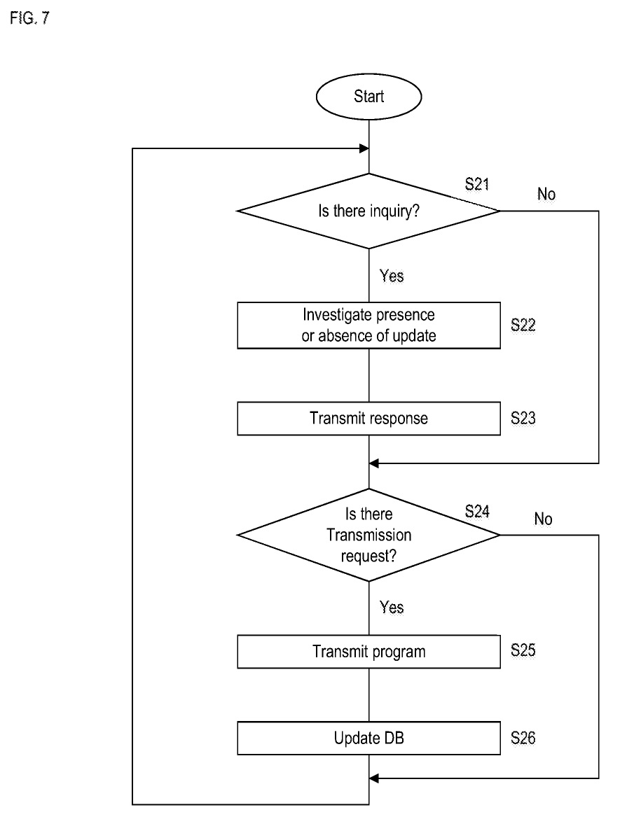

FIG. 7 is a flowchart showing a procedure of an update program transmission process performed by the server apparatus 9. The server apparatus 9 determines whether an inquiry about whether to update the programs of the ECUs 2 has been received from the gateway 4 of the vehicle 1 (step S21). If no inquiry has been received (NO in step S21), the server apparatus 9 moves the process to step S24. If an inquiry has been received (YES in step S21), the server apparatus 9 accesses the database that records the versions and the like of the programs of the vehicle 1, and investigates the presence or absence of updating of the programs of the ECUs 2 of the vehicle 1 concerning the inquiry (step S22). The server apparatus 9 transmits, as a response, the presence or absence of the update obtained as the result of the investigation to the gateway 4 that has sent the inquiry (step S23), and moves the process to step S24.

Next, the server apparatus 9 determines whether a transmission request for an update program has been received from the gateway 4 of the vehicle 1 (step S24). If no transmission request has been received (NO in step S24), the server apparatus 9 returns the process to step S21. If a transmission request has been received (YES in step S24), the server apparatus 9 reads out an update program for the ECU 2 to be updated of the vehicle 1 that has sent the request, and transmits the update program to the gateway 4 that has sent the request (step S25). After the update program has been transmitted, the server apparatus 9 updates the database for recording that the update program has been transmitted (step S26), and returns the process to step S21.

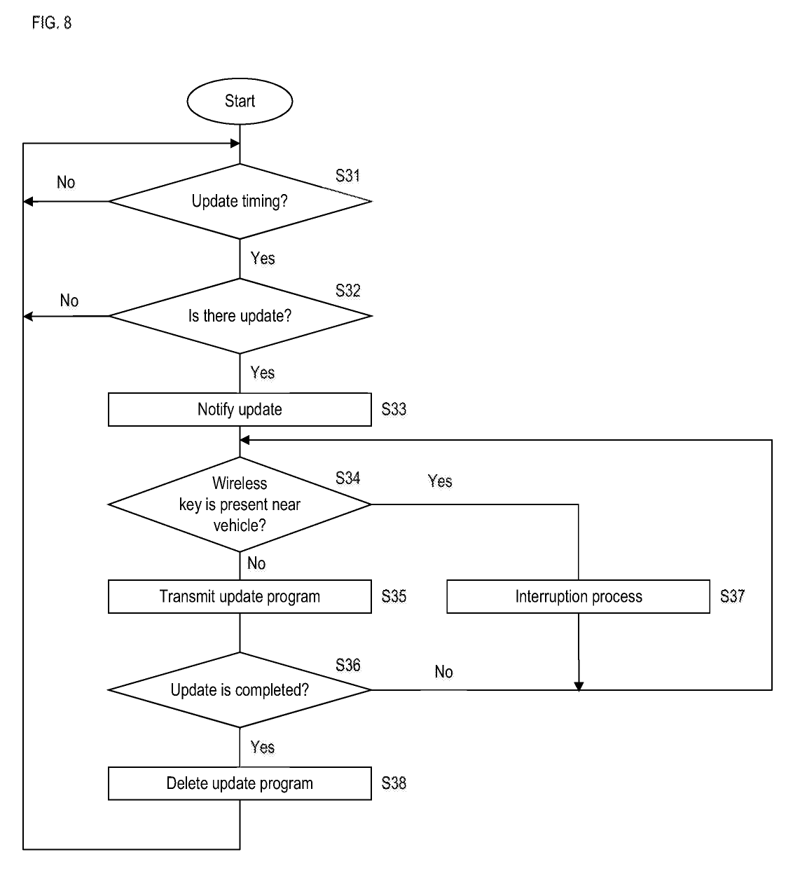

FIG. 8 is a flowchart showing a procedure of an update process performed by the gateway 4. The processing unit 41 of the gateway 4 determines whether the timing for performing the predetermined update process has been reached (step S31). The timing includes, for example, a case in which the IG switch of the vehicle 1 has been turned to the off state and a predetermined time has been reached. If the timing for performing the update process has not been reached (NO in step S31), the processing unit 41 waits until the timing for performing the update process is reached. If the timing for performing an update process has been reached (YES in step S31), the processing unit 41 investigates whether an unused update program is stored in the storage unit 12 to determine whether an update process needs to be performed (step S32). If no update process needs to be performed (NO in step S32), the processing unit 41 returns the process to step S31. If an update process needs to be performed (YES in step S32), the processing unit 41 notifies, through the in-vehicle communication unit 43, the ECU 2 to be updated that an update process is performed (step S33).

Next, the distance determination unit 41d determines whether the signal strength of the radio signal received by the BCM 6 from the wireless key 7 exceeds a threshold based on the communication result received by the communication result receiving unit 41c from the BCM 6, and the processing unit 41 determines whether the wireless key 7 is present near the vehicle 1 (step S34). If the wireless key 7 is not present near the vehicle 1 (NO in step S34), the update information transmission unit 41b of the processing unit 41 reads out an update program stored in the storage unit 42 and transmits the update program to the ECU 2 to be updated (step S35). At this time, the update information transmission unit 41b divides the update program stored in the storage unit 42 into predetermined data sizes, and sequentially transmits the divided update programs to the ECU 2. The update information transmission unit 41b investigates whether the update program stored in the storage unit 42 has been transmitted to determine whether the update process of the ECU 2 has been completed (step S36). If the update process has not been completed (NO in step S36), the processing unit 41 returns the process to step S34.

In step S34, if the wireless key 7 is present near the vehicle 1 (YES in step S34), the interruption unit 41e of the processing unit 41 interrupts the transmission of the update program by the update information transmission unit 41b and notifies the ECU 2 that the update process is interrupted (step S37). If the wireless key 7 is not present near the vehicle 1 and the cause for interrupting the update process has been eliminated, then the interruption unit 41e again notifies the ECU 2 whose update process was interrupted that the update process is performed, and returns the process to step S34. The processing unit 41 continuously transmits the update program to the ECU 2, while transmitting the update program to the ECU 2 and interrupting the transmission as necessary. If the update process has been completed (YES in step S36), the processing unit 41 deletes the update program that has been used for the update process from the storage unit 42 (step S38), and returns the process to step S31.

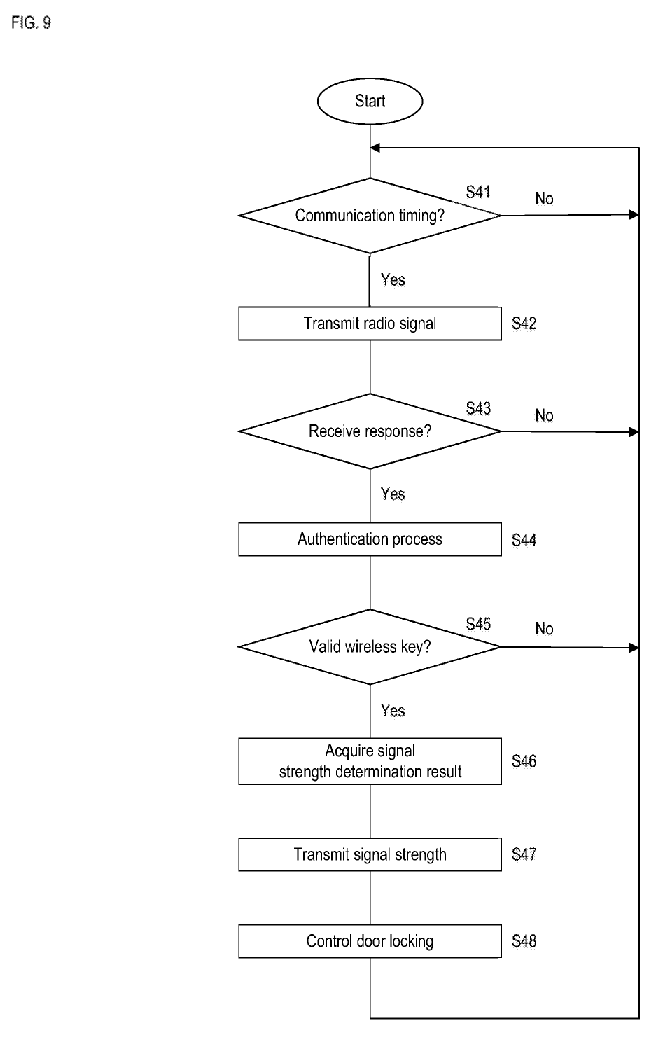

FIG. 9 is a flowchart showing a procedure of processes performed by the BCM 6. The BCM 6 attempts, for example, wireless communication with the wireless key 7 at a cycle of about several milliseconds to several seconds. The communication processing unit 61a of the processing unit 61 determines whether the timing for performing wireless communication with the wireless key 7 has been reached (step S41). If timing has not reached the timing for performing wireless communication (NO in step S41), the communication processing unit 61a waits until the timing for performing wireless communication is reached. If the timing for performing wireless communication has been reached (YES in step S41), the communication processing unit 61a transmits a predetermined radio signal from the antenna 66 (step S42). If the wireless key 7 is present within the reachable range of this radio signal, the wireless key 7 that has received the radio signal responds by wireless communication to notify that the radio signal has been received.

The communication processing unit 61a of the BCM 6 determines whether a response has been received from the wireless key 7 (step S43). If no response has been received (NO in step S43), the communication processing unit 61a returns the process to step S41. If a response from the wireless key 7 has been received (YES in step S43), the communication processing unit 61a exchanges information with the wireless key 7 by wireless communication, and preforms an authentication process based on the acquired information (step S44). Based on the result of the authentication process, the communication processing unit 61a determines whether the wireless key 7 with which the communication processing unit 61a performs wireless communication is a valid wireless key 7 (step S45). If the wireless key 7 is not a valid wireless key 7 (NO in step S45), the communication processing unit 61a returns the process to step S41.

If the wireless key 7 with which the communication processing unit 61a preforms wireless communication is a valid wireless key 7 (YES in step S45), the communication result transmission unit 61c of the processing unit 61 acquires a determination result of the signal strength of the radio signal received from the wireless key 7, which is determined by the signal strength determination unit 67 (step S46). The communication result transmission unit 61c transmits the acquired determination result of the signal strength to the gateway 4 through the in-vehicle communication unit 63 (step S47). The door locking control unit 61b of the processing unit 61 controls the locking/unlocking of the doors of the vehicle 1 according to wireless communication with the wireless key 7 (step S48), and returns the process to step S41.

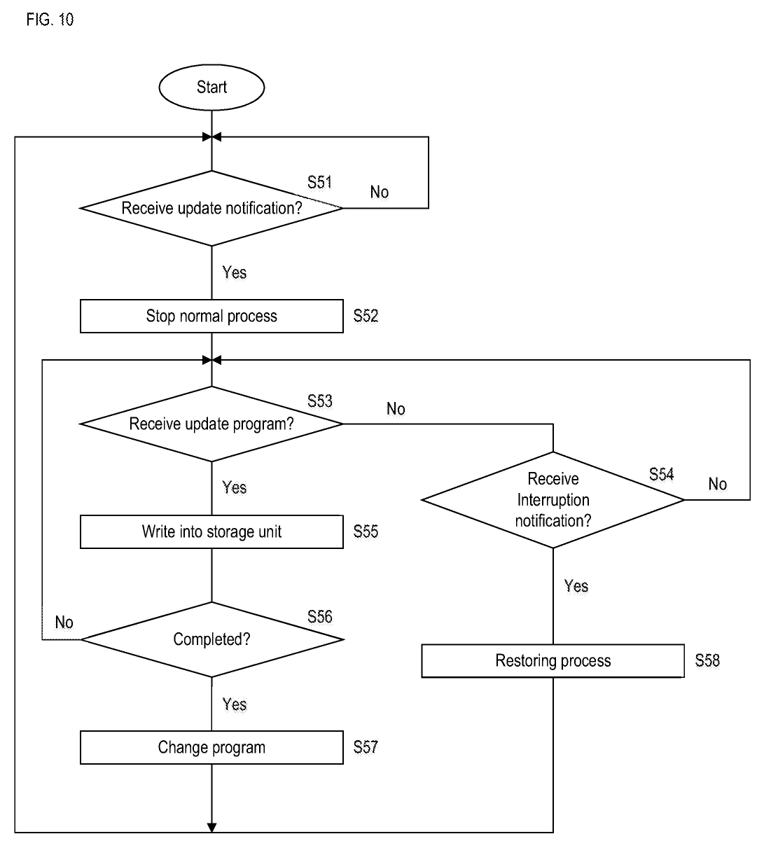

FIG. 10 is a flowchart showing a procedure of an update process performed by the ECU 2. The processing unit 21 of each of the ECUs 2 determines whether a notification for performing an update process of the program 22a stored in the storage unit 22 has been received from the gateway 4 (step S51). If no notification has been received (NO in step S51), the processing unit 21 waits until the processing unit 21 receives the notification for performing an update process. If a notification for performing an update process has been received (YES in step S51), the processing unit 21 stops the normal process performed by the program 22a stored in the storage unit 22 (step S52), and changes the mode from the normal operation mode to the mode for performing an update process.

The update information receiving unit 21a of the processing unit 21 determines whether the update program (the update program divided into chunks of predetermined data sizes) transmitted from the gateway 4 has been received (step S53). If the update program has been received (YES in step S53), the update information writing unit 21b of the processing unit 21 writes the received update program into the free space 22b of the storage unit 22 (step S55). The processing unit 21 determines whether the entire divided program to be received from the gateway 4 has been received and written (step S56). If not the entire update program has been written (NO in step S56), the processing unit 21 returns the process to step S53. If the entire update program has been written (YES in step S56), the updating unit 21c of the processing unit 21 invalidates the pre-update program 22a stored in the storage unit 22 and validates the newly-stored update program 22a. Then, the updating unit 21c of the processing unit 21 switches the program 22a executed by the processing unit 21 (step S57), and returns the process to step S51. As a result, the mode of the ECU 2 is changed from the mode for performing the update process to the normal operation mode performed by the updated program 22a.

If the update program has not been received from the gateway 4 (NO in step S53), the processing unit 21 determines whether a notification of the interruption of the update process has been received from the gateway 4 (step S54). If no notification of the interruption has been received (NO in step S54), the processing unit 21 returns the process to step S53, and waits until the processing unit 21 receives the update program or a notification of the interruption of the update process from the gateway 4. If a notification of the interruption of the update process has been received (YES in step S54), the restoring unit 21d of the processing unit 21 interrupts the reception and writing of the update program, restores the operation to the operation performed by the pre-update program 22a stored in the storage unit 22 (step S58), and returns the process to step S51. As a result, the mode of the ECU 2 is changed from the mode for performing the update process to the normal operation mode performed by the pre-update program 22a.

In the on-board update system according to the present embodiment having the above configuration, an update process is performed by an update program stored in the storage unit 42 of the gateway 4 being transmitted to the ECU 2 and the ECU 2 writing the received update program into its own storage unit 22. Note, that each ECU 2 has the first storage region that stores a pre-update program 22a and the second storage region (the free space 22b) into which an update program is written in its storage unit 22, and can write the update program received from the gateway 4 into the storage unit 22 without overwriting the pre-update program 22a. After the update program has been written, the ECU 2 updates the program 22a by changing the program to be booted by the processing unit 21 from the pre-update program 22a stored in the storage unit 22 to the newly-written update program 22a.

Furthermore, in the on-board update system according to the present embodiment, the BCM 6 performs wireless communication with the wireless key 7 that the user or the like of the vehicle 1 has, and the BCM 6 transmits the information of the signal strength of the received signal, which is the result of the wireless communication, to the gateway 4. The gateway 4 determines whether the wireless key 7 is present near the vehicle 1 according to whether the signal strength exceeds the threshold. If the wireless key 7 is present near the vehicle 1, the gateway 4 interrupts the transmission of an update program to the ECU 2 to interrupt an update process. The ECU 2 in which the transmission of an update program is interrupted and an update process is interrupted interrupts the writing of the update program into the storage unit 22, and returns to the operation performed by the pre-update program stored in the storage unit 22.

If the wireless key 7 is present near the vehicle 1, it can be assumed that there is a high possibility that the user who has this wireless key 7 is present near the vehicle 1 and the vehicle 1 will be used. In such a case, by interrupting an update process of the ECU 2 and restoring to the original state, the user can use the vehicle 1 even during an update process. Accordingly, the on-board update system according to the present embodiment can perform update processes of the ECUs 2 without limiting the use of the vehicle for the convenience of the user.

Note, that in the present embodiment, the portable communication device with which the BCM 6 performs wireless communication is the wireless key 7 of the vehicle 1, but the portable communication device is not limited to this. A configuration may also be employed, for example, in which wireless communication is performed with a communication device such as a portable telephone or a smartphone that the user has and it is determined whether the communication device is present near the vehicle 1. The configuration in which the gateway 4 installed in the vehicle 1 acquires update programs from the server apparatus 9 and performs the transmission or the like of the update program to each ECU 2, that is, the configuration in which the gateway 4 serves as the on-board update apparatus is employed, but the configuration is not limited to this. A configuration in which any one of the ECUs 2, the TCU 5, the BCM 6, or any other on-board device performs the processes as the on-board update apparatus may also be employed. Also, a configuration is employed in which update programs are acquired from the server apparatus 9 located outside of the vehicle by wireless communication, but the configuration is not limited to this. A configuration may also be employed, for example, in which update programs are acquired by the gateway 4 reading a recording medium in which the update programs are recorded. The communication apparatuses to be updated are the ECUs 2, but the communication apparatuses to be updated are not limited to the ECUs 2. Various communication apparatuses other than the ECUs 2 may also be apparatuses to be updated.

Also, the function for performing an update process by connecting an update apparatus for updating the program 22a to the in-vehicle network at the dealer or the like of the vehicle 1 and transmitting update programs to the ECUs 2 from the update apparatus may also be employed in conjunction with the above-mentioned function for performing an update process by the gateway 4 transmitting update programs acquired from the server apparatus 9 to the ECUs 2. Note, that in this configuration, an update process does not need to be interrupted even if the wireless key 7 is present near the vehicle 1 while an update process is performed using the update apparatus at the dealer or the like.

In the present embodiment, a configuration is employed in which the door is unlocked when the wireless key 7 that the user has approaches the vehicle 1, but the configuration is not limited to this. A configuration may also be employed, for example, in which the door of the vehicle 1 is unlocked if the user who has the wireless key 7 operates the switch provided on the door of the vehicle 1, or if the user operates the switch provided on the wireless key 7. In such a configuration, the BCM 6 does not need to periodically transmit a radio signal. The BCM 6 may have a configuration in which the BCM 6 performs an authentication process with the wireless key 7 if, for example, the switch of the door of the vehicle 1 is operated, or if a radio signal transmitted from the wireless key 7 in response to the operation is received, and notifies the gateway 4 that wireless communication with the valid wireless key 7 has been established as a communication result. The gateway 4 may have a configuration in which the gateway 4 interrupts an update process of the ECU 2 if a notification for notifying that wireless communication with the valid wireless key 7 has been established is received from the BCM 6.

### Second Embodiment

The on-board update system according to the first embodiment has a configuration in which the BCM 6 transmits the information of the signal strength of the radio signal received from the wireless key 7 to the gateway 4 and the gateway 4 determines whether the wireless key 7 is present near the vehicle 1 based on this signal strength.

On the other hand, an on-board update system according to a second embodiment has a configuration in which the BCM 6 determines whether the wireless key 7 is present near the vehicle 1 based on the signal strength of the radio signal received from the wireless key 7.

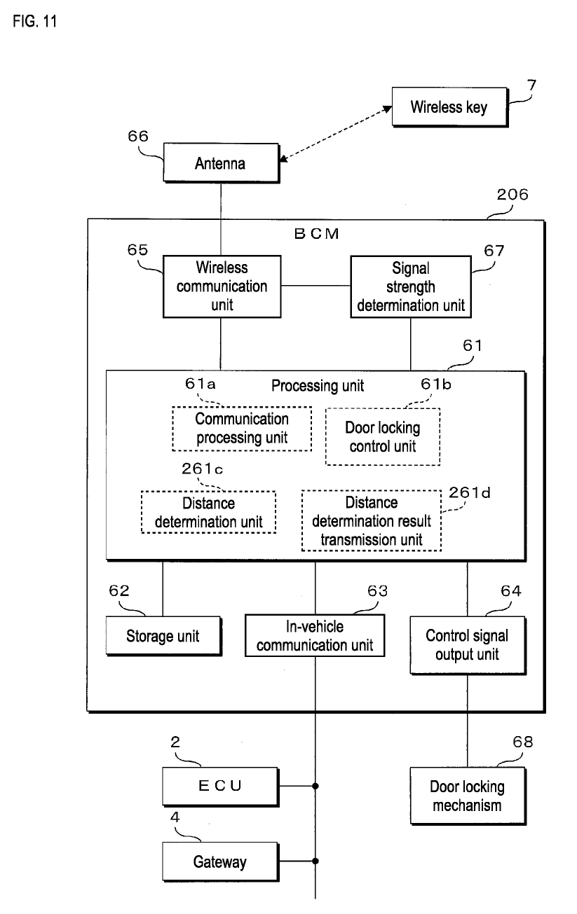

FIG. 11 is a block diagram showing the configuration of a BCM 206 according to the second embodiment. The BCM 206 according to the second embodiment has a configuration in which a distance determination unit 261c and a distance determination result transmission unit 261d are provided in the processing unit 61 instead of the communication result transmission unit 61c provided in the processing unit 61 of the BCM 6 according to the first embodiment shown in FIG. 5. The distance determination unit 261c determines whether the wireless key 7 is present within the predetermined distance from the vehicle 1 by determining, based on the signal strength of the radio signal from the wireless key 7 determined by the signal strength determination unit 67, whether this signal strength exceeds a predetermined strength. The distance determination result transmission unit 261d transmits the determination result by the distance determination unit 261c to a gateway 204 every time wireless communication is performed with the wireless key 7 by the wireless communication unit 65.

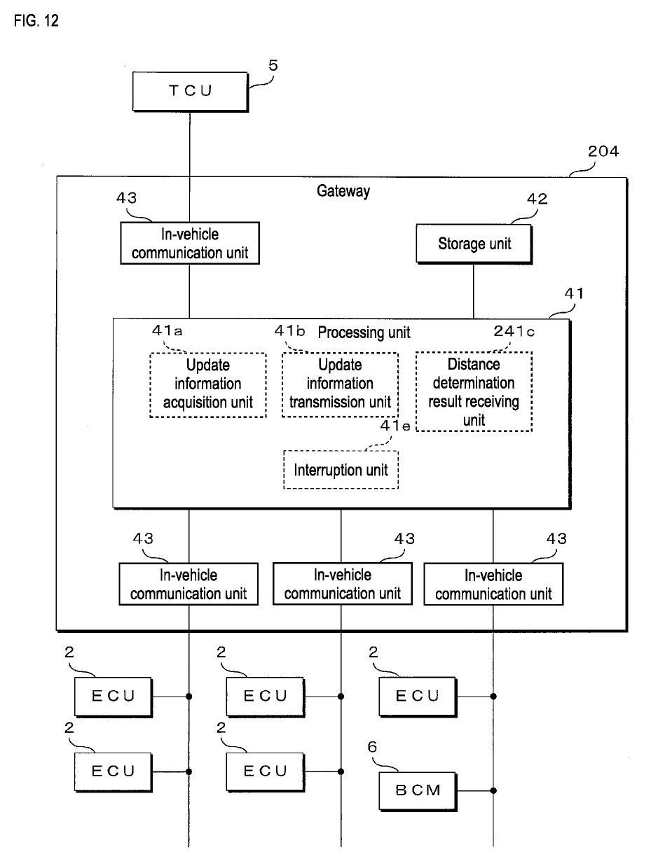

FIG. 12 is a block diagram showing the configuration of the gateway 204 according to the second embodiment. The gateway 204 according to the second embodiment has a configuration in which the distance determination unit 41d provided in the processing unit 41 of the gateway 4 according to the first embodiment shown in FIG. 4 is not provided and a distance determination result receiving unit 241c is provided instead of the communication result receiving unit 41c. The distance determination result receiving unit 241c receives, from the BCM 206, the determination result for determining whether the wireless key 7 is present near the vehicle 1 through the in-vehicle communication unit 43 connected to the in-vehicle network. The distance determination result receiving unit 241c provides the received determination result to the interruption unit 41e. The interruption unit 41e interrupts the transmission of an update program to the ECU 2 by the update information transmission unit 41b according to the determination result provided from the distance determination result receiving unit 241c, and interrupts the update process of the program 22a of the ECU 2.

The on-board update system according to the second embodiment having the above configuration has the configuration in which the BCM 206 performs the distance determination based on the signal strength of the radio signal received from the wireless key 7 and transmits the determination result to the gateway 204. As mentioned above, any apparatus installed in the vehicle 1 may perform the distance determination based on the signal strength of the radio signal received form the wireless key 7.

Note, that because other configurations of the on-board update system according to the second embodiment are the same as those of the on-board update system according to the first embodiment, the same numerals are given to the same units and a detailed description thereof will be omitted.

### Third Embodiment

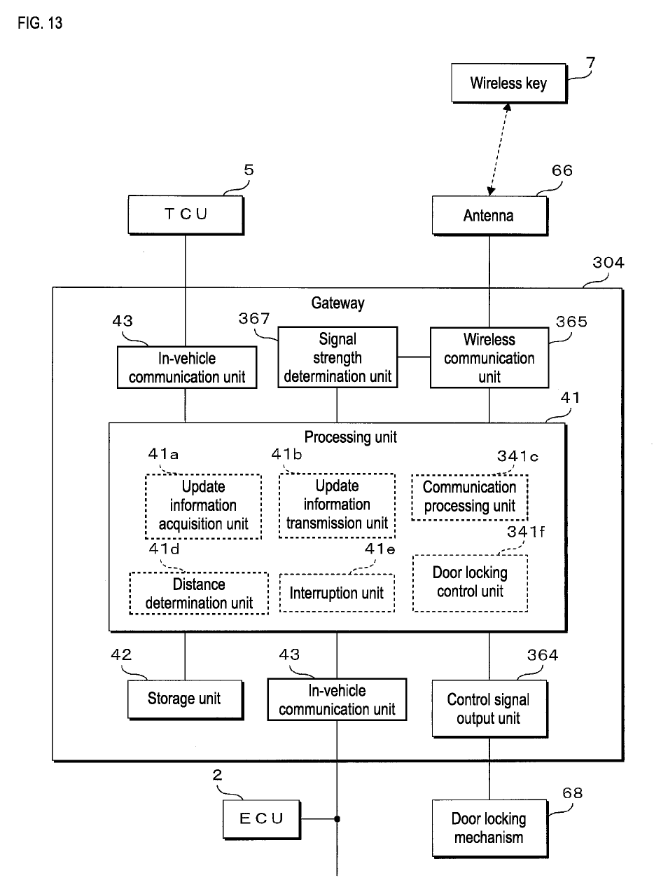

An on-board update system according to a third embodiment has a configuration in which the functions of the gateway 4 and the BCM 6 of the on-board update system according to the first embodiment are integrated in one gateway. FIG. 13 is a block diagram showing the configuration of a gateway 304 according to the third embodiment. The gateway 304 according to the third embodiment includes the processing unit 41, the storage unit 42, the plurality of in-vehicle communication units 43, a control signal output unit 364, a wireless communication unit 365, and a signal strength determination unit 367. Note, that in FIG. 13, only one in-vehicle communication unit 43 connected to the ECU 2 via the communication line is shown in order to simplify the drawing. The gateway 304 actually includes two or more similar in-vehicle communication units 43.

The processing unit 41 performs computations necessary for the processes such as the process for relaying data transmission and reception between the communication lines, the process for performing wireless communication with the wireless key 7, the process for locking/unlocking the door of the vehicle 1 according to the result of this wireless communication, and the process for performing update processes of the ECUs 2. The storage unit 42 stores, for example, programs executed by the processing unit 41 and data necessary for executing these programs, and also stores update programs for the ECUs 2. To transmit information, the in-vehicle communication unit 43 converts the data provided from the processing unit 41 into an electric signal, and outputs the electric signal to the communication line. To receive data, the in-vehicle communication unit 43 samples the electrical potential at the communication line, and provides the received data to the processing unit 41.

The control signal output unit 364 outputs, based on the process by the processing unit 41, a control signal for controlling the operations of the door locking mechanisms 68, and locks and unlocks the doors of the vehicle 1. The wireless communication unit 365 performs wireless communication with the wireless key 7 by transmitting and receiving radio signals via the antenna 66 arranged in the appropriate place in the vehicle 1. The signal strength determination unit 367 determines the signal strength of the radio signal received by the wireless communication unit 365 from the wireless key 7, and provides the determination result to the processing unit 41.

The processing unit 41 executes the programs stored in the storage unit 42, ROM, or the like, and thereby enables software-like functional blocks such as the update information acquisition unit 41a, the update information transmission unit 41b, a communication processing unit 341c, the distance determination unit 41d, the interruption unit 41e, and a door locking control unit 341f. The update information acquisition unit 41a acquires update programs from the server apparatus 9 via the TCU 5 and stores the acquired update programs into the storage unit 42. The update information transmission unit 41b reads out the update program acquired from the server apparatus 9 and stored in the storage unit 42 at a predetermined timing, and transmits the read-out update program to the ECU 2 to be updated.

The communication processing unit 341c performs processes related to wireless communication performed with the wireless key 7. The distance determination unit 41d determines whether the wireless key 7 is present within the predetermined distance from the vehicle 1 by determining, based on the signal strength of the radio signal from the wireless key 7 determined by the signal strength determination unit 367, whether this signal strength exceeds the predetermined strength. The interruption unit 41e interrupts the transmission of the update program to the ECU 2 by the update information transmission unit 41b according to the determination result of the distance determination unit 41d, and interrupts the update process of the program 22a of the ECU 2. The door locking control unit 341f controls the locking/unlocking of the doors of the vehicle 1 by the door locking mechanisms 68 according to the result of communication with the wireless key 7 by the communication processing unit 341c.

The on-board update system according to the third embodiment having the above configuration has a configuration in which one apparatus (the gateway 304) performs the processes such as the process for relaying the communication between the communication lines, the process for performing wireless communication with the wireless key 7, the process for locking/unlocking the doors of the vehicle 1, and the process for performing update processes of the ECUs 2. The configuration in which one apparatus performs these processes can reduce the number of apparatuses installed in the vehicle 1. Furthermore, a configuration in which the gateway 304 also performs the functions of the TCU 5 may also be employed.

Note, that because other configurations of the on-board update system according to the third embodiment are the same as those of the on-board update system according to the first embodiment, the same numerals are given to the same units and a detailed description thereof will be omitted.

### Fourth Embodiment

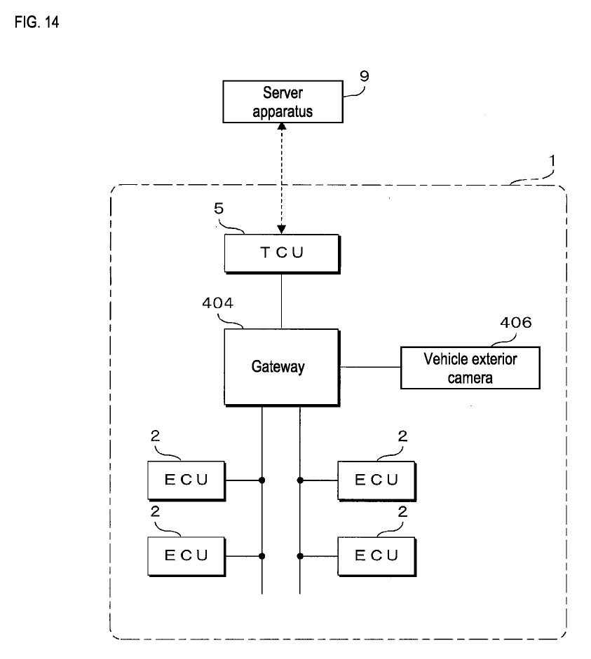

FIG. 14 is a schematic diagram showing the configuration of an on-board update system according to a fourth embodiment. The on-board update system according to the fourth embodiment includes a vehicle exterior camera 406 that captures the surroundings of the vehicle 1. The vehicle exterior camera 406 captures the surroundings of the vehicle 1 at a predetermined cycle, and inputs the captured images to the gateway 404 via the in-vehicle network. Note, that the vehicle exterior camera 406 is preferably configured to be able to capture the surroundings of the vehicle 1 over 360°, but the vehicle exterior camera 406 may also be configured to capture only a part of the surroundings of the vehicle 1. In this case, the vehicle exterior camera 406 is preferably configured to capture at least the vicinity of the door of the driver's seat of the vehicle 1. Note, that the vehicle exterior camera 406 may be configured with a plurality of cameras.

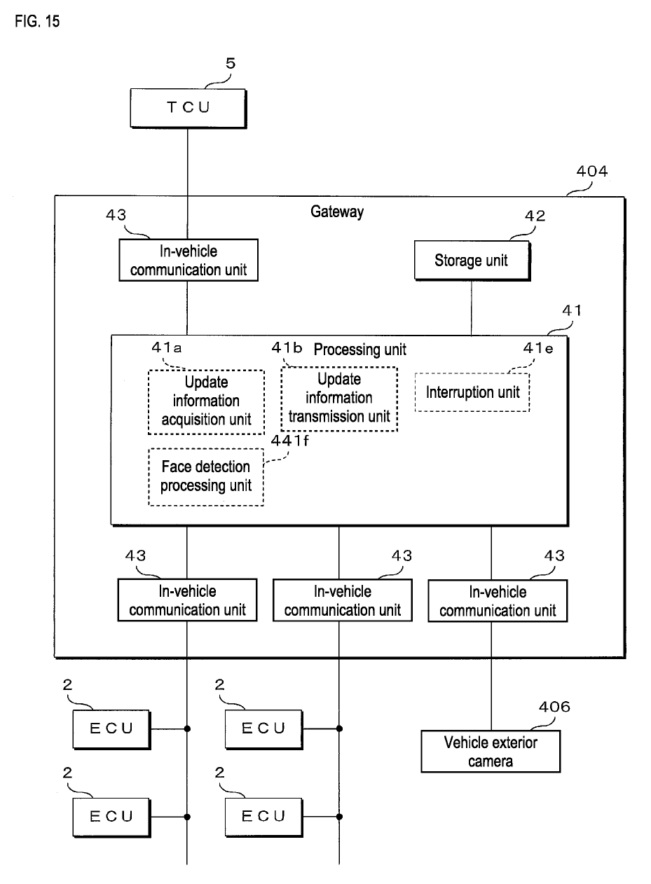

FIG. 15 is a block diagram showing the configuration of a gateway 404 according to the fourth embodiment. In the gateway 404 according to the fourth embodiment, the processing unit 41 is provided with a face detection processing unit 441f as a software-like functional block. The face detection processing unit 441f detects a face of a person from images input from the vehicle exterior camera 406.

Furthermore, the face detection processing unit 441f determines whether the face detected from the images captured by the vehicle exterior camera 406 matches the pre-registered face of the user of the vehicle 1. Note, that because the determination process, which is performed by the face detection processing unit 441f, for detecting a face of a person and determining whether the detected face matches the registered face is a known technique, the detailed description thereof will be omitted.

If the face detection processing unit 441f detects a face of the user of the vehicle 1 from the image captured by the vehicle exterior camera 406, the interruption unit 41e of the gateway 404 according to the fourth embodiment interrupts the transmission of an update program to the ECU 2 by the update information transmission unit 41b, and interrupts an update process of the program 22a of the ECU 2. The ECU 2 whose update process is interrupted returns to the operation performed by the pre-update program 22a by the restoring unit 21d.

In the on-board update system according to the fourth embodiment having the above configuration, the vehicle exterior camera 406 captures the surroundings of the vehicle 1, and the gateway 404 interrupts the transmission of an update program to the ECU 2 according to the capturing result. The gateway 404 may be, for example, configured to detect a face of a person from the images captured by the vehicle exterior camera 406, and interrupt the transmission of an update program if a face is detected. Furthermore, a configuration can be employed in which face authentication for determining whether the detected face matches the face registered as the user of the vehicle 1 is performed, and the transmission of an update program is interrupted according to the authentication result. In this manner, it is possible to interrupt an update process if the user who may use the vehicle 1 is present near the vehicle 1.

Note, that in the fourth embodiment, a configuration is employed in which the gateway 404 acquires the images captured by the vehicle exterior camera 406, and the gateway 404 performs the processes such as face detection, but the configuration is not limited to this. A configuration may also be employed, for example, in which the vehicle exterior camera 406 performs such processes as face detection and notifies the gateway 404 of the processing result.

Note, that because other configurations of the on-board update system according to the fourth embodiment are the same as those of the on-board update system according to the first embodiment, the same numerals are given to the same units and a detailed description thereof will be omitted.

### Fifth Embodiment

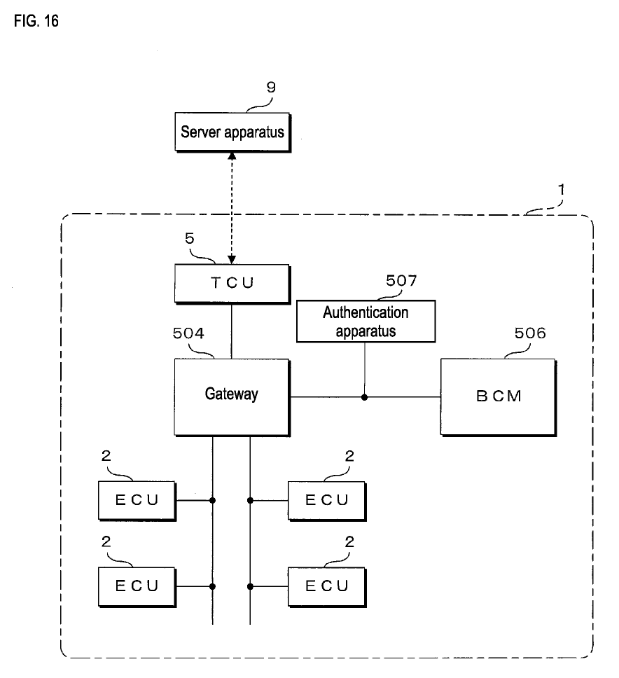

FIG. 16 is a schematic diagram showing the configuration of an on-board update system according to a fifth embodiment. An on-board update system according to the fifth embodiment includes an authentication apparatus 507. The authentication apparatus 507 is an apparatus for authenticating the user, for example, by acquiring information of the fingerprint or the vein, which is biological information of the user, and determining whether the acquired biological information matches the pre-registered biological information.

In the on-board update system according to the fifth embodiment, an apparatus (which may also be a portion of the authentication apparatus 507) for acquiring the biological information of the user is provided on the outside of the door of the vehicle 1, and the authentication apparatus 507 performs an authentication process based on the biological information acquired by this apparatus. The result of the authentication process performed by the authentication apparatus 507 is provided to a BCM 506. If the authentication apparatus 507 determines that the acquired biological information matches the registered biological information, that is, if the result of the authentication success is provided from the authentication apparatus 507, the BCM 506 unlocks the door of the vehicle 1.

Also, in the on-board update system according to the fifth embodiment, the authentication result of the authentication apparatus 507 is provided to a gateway 504. If the result of the authentication success is provided from the authentication apparatus 507, the interruption unit 41e of the gateway 504 interrupts the transmission of an update program to the ECU 2 by the update information transmission unit 41b, and interrupts an update process of the program 22a of the ECU 2. The ECU 2 whose update process is interrupted returns to the operation performed by the pre-update program 22a by the restoring unit 21d.

The on-board update system according to the fifth embodiment having the above configuration acquires biological information of a person, and interrupts the transmission of an update program according to the acquired biological information. In the system in which the authentication apparatus 507 acquires the biological information such as the fingerprint information or the vein information of the user of the vehicle 1, an authentication process of the fingerprint authentication, the vein authentication, or the like is performed, and the BCM 506 can unlock the door, start the engine of the vehicle 1, or the like only if the authentication succeeds, a configuration may be employed in which the gateway 504 interrupts an update process if the authentication succeeds. With this configuration, it is possible to interrupt an update process if there is a high possibility that the user may use the vehicle 1.

Note, that in the fifth embodiment, a configuration is employed in which the authentication apparatus 507 acquires biological information, preforms an authentication process, and notifies the gateway 504 and the BCM 506 of the authentication result, but the configuration is not limited to this. A configuration may also be employed, for example, in which the BCM 506 acquires biological information, performs an authentication process, and notifies the gateway 504 of the authentication result. Also, a configuration may be employed, for example, in which the gateway 504 acquires biological information, performs an authentication process, and notifies the BCM 506 of the authentication result.

Note, that because other configurations of the on-board update system according to the fifth embodiment are the same as those of the on-board update system according to the first embodiment, the same numerals are given to the same units and a detailed description thereof will be omitted.

1. An on-board update system configured to update a program or data stored in a storage unit of an on-board device that is installed in a vehicle and includes the storage unit, which is configured to store the program or data, and a processing unit, which is configured to read out and execute the program or data stored in the storage unit, the on-board update system comprising:
an update storage unit configured to store an update program or data;
an update information transmission unit configured to transmit the update program or data stored in the update storage unit to the on-board device;
an interruption unit configured to interrupt the transmission of the update program or data by the update information transmission unit to the on-board device; and
a camera configured to capture the surroundings of the vehicle,
wherein the storage unit of the on-board device includes a first storage region in which a program or data being executed by the processing unit is stored and a second storage region configured to store the update program or data, and
the on-board device includes:
an update information receiving unit configured to receive the update program or data transmitted by the update information transmission unit;
an update information writing unit configured, if the update information receiving unit receives the update program or data, to stop the execution of the program or data stored in the first storage region by the processing unit, and to write the update program or data received by the update information receiving unit into the second storage region;
a restoring unit configured to restore the execution of the program or data stored in the first storage region by the processing unit if the interruption unit interrupts the transmission; and
an updating unit configured, after the writing of the update program or data into the second storage region is completed, to change a program or data to be executed by the processing unit from the program or data stored in the first storage region to the program or data stored in the second storage region, and
the interruption unit interrupts the transmission of the update program or data depending on a capturing result of the camera.

2. The on-board update system according to claim 1, wherein
the interruption unit interrupts the transmission of the update program or data depending on the circumstances around the vehicle.

3. The on-board update system according to claim 2, wherein
the interruption unit interrupts the transmission of the update program or data if a user of the vehicle is present around the vehicle.

4. The on-board update system according to claim 1, further comprising:
a wireless communication unit configured to perform wireless communication with a portable communication device,
wherein the interruption unit interrupts the transmission of the update program or data depending on a result of communication with the communication device by the wireless communication unit.

5. The on-board update system according to claim 4, further comprising:
a distance determination unit configured to determine a distance to the communication device depending on a result of communication with the communication device by the wireless communication unit,
wherein the interruption unit interrupts the transmission if the distance determined by the distance determination unit is shorter than a predetermined distance.

6. The on-board update system according to claim 5, further comprising:
a wireless communication apparatus that includes the wireless communication unit, the distance determination unit, and a distance determination result transmission unit configured to transmit a determination result by the distance determination unit; and
an on-board update apparatus that includes the update storage unit, an update information acquisition unit configured to acquire an update program or data from an apparatus outside the vehicle and to store the acquired update program or data to the update storage unit, a distance determination result receiving unit configured to receive a determination result transmitted by the distance determination result transmission unit of the wireless communication apparatus, and the interruption unit.

7. The on-board update system according to claim 5, further comprising:
a wireless communication apparatus that includes the wireless communication unit, and a communication result transmission unit configured to transmit a result of communication with the communication device by the wireless communication unit; and
an on-board update apparatus that includes the update storage unit, an update information acquisition unit configured to acquire an update program or data from an apparatus outside the vehicle and to store the acquired update program or data to the update storage unit, a communication result receiving unit configured to receive a communication result transmitted by the communication result transmission unit of the wireless communication apparatus, the distance determination unit, and the interruption unit.

8. The on-board update system according to claim 5, further comprising:
an on-board update apparatus that includes the wireless communication unit, the distance determination unit, the update storage unit, an update information acquisition unit configured to acquire an update program or data from an apparatus outside the vehicle and to store the acquired update program or data to the update storage unit, and the interruption unit.

9. The on-board update system according to claim 1, further comprising:
a face detection unit configured to detect a face of a person from an image captured by the camera,
wherein the interruption unit interrupts the transmission of the update program or data if the face detected by the face detection unit matches a registered face.

10. An on-board update system configured to update a program or data stored in a storage unit of an on-board device that is installed in a vehicle and includes the storage unit, which is configured to store the program or data, and a processing unit, which is configured to read out and execute the program or data stored in the storage unit, the on-board update system comprising:
an update storage unit configured to store an update program or data;
an update information transmission unit configured to transmit the update program or data stored in the update storage unit to the on-board device;
an interruption unit configured to interrupt the transmission of the update program or data by the update information transmission unit to the on-board device; and
a biological information acquisition unit configured to acquire biological information of a person,
wherein the storage unit of the on-board device includes a first storage region in which a program or data being executed by the processing unit is stored and a second storage region configured to store the update program or data, and
the on-board device includes:
an update information receiving unit configured to receive the update program or data transmitted by the update information transmission unit;
an update information writing unit configured, if the update information receiving unit receives the update program or data, to stop the execution of the program or data stored in the first storage region by the processing unit, and to write the update program or data received by the update information receiving unit into the second storage region;
a restoring unit configured to restore the execution of the program or data stored in the first storage region by the processing unit if the interruption unit interrupts the transmission; and
an updating unit configured, after the writing of the update program or data into the second storage region is completed, to change a program or data to be executed by the processing unit from the program or data stored in the first storage region to the program or data stored in the second storage region, and
the interruption unit interrupts the transmission of the update program or data depending on the biological information acquired by the biological information acquisition unit.

11. An on-board update apparatus configured to update a program or data stored in a storage unit of an on-board device that is installed in a vehicle and includes the storage unit, which is configured to store the program or data, and a processing unit, which is configured to read out and execute the program or the data stored in the storage unit, the on-board update apparatus comprising:
an update information acquisition unit configured to acquire an update program or data from an apparatus outside the vehicle;
an update storage unit configured to store the update program or data acquired by the update information acquisition unit;
an update information transmission unit configured to transmit the update program or data stored in the update storage unit to the on-board device; and
an interruption unit configured to interrupt the transmission of the update program or data by the update information transmission unit to the on-board device,
wherein the interruption unit interrupts the transmission of the update program or data depending on a capturing result of a camera configured to capture the surroundings of the vehicle.

12. An on-board update apparatus configured to update a program or data stored in a storage unit of an on-board device that is installed in a vehicle and includes the storage unit, which is configured to store the program or data, and a processing unit, which is configured to read out and execute the program or the data stored in the storage unit, the on-board update apparatus comprising:
an update information acquisition unit configured to acquire an update program or data from an apparatus outside the vehicle;
an update storage unit configured to store the update program or data acquired by the update information acquisition unit;
an update information transmission unit configured to transmit the update program or data stored in the update storage unit to the on-board device; and
an interruption unit configured to interrupt the transmission of the update program or data by the update information transmission unit to the on-board device,
wherein the interruption unit interrupts the transmission of the update program or data depending on biological information acquired by a biological information acquisition unit configured to acquire biological information of a person.

13. An update method for updating a program or data stored in a storage unit of an on-board device that is installed in a vehicle and includes the storage unit, which is configured to store the program or data, and a processing unit, which is configured to read out and execute the program or data stored in the storage unit,
the storage unit of the on-board device including a first storage region in which a program or data being executed by the processing unit is stored and a second storage region configured to store an update program or data, the update method comprising the steps of:
transmitting the update program or data stored in an update storage unit to the on-board device;
interrupting the transmission of the update program or data to the on-board device depending on a capturing result of a camera configured to capture the surroundings of the vehicle;
the on-board device, if the update program or data is received, stopping the execution of the program or data stored in the first storage region by the processing unit, and writing the received update program or data into the second storage region;
the on-board device restoring the execution of the program or data stored in the first storage region by the processing unit if the transmission of the update program or data is interrupted; and
the on-board device, after the writing of the update program or data into the second storage region is completed, changing a program or data to be executed by the processing unit from the program or data stored in the first storage region to the program or data stored in the second storage region.

14. An update method for updating a program or data stored in a storage unit of an on-board device that is installed in a vehicle and includes the storage unit, which is configured to store the program or data, and a processing unit, which is configured to read out and execute the program or data stored in the storage unit,
the storage unit of the on-board device including a first storage region in which a program or data being executed by the processing unit is stored and a second storage region configured to store an update program or data, the update method comprising the steps of:
transmitting the update program or data stored in an update storage unit to the on-board device;
interrupting the transmission of the update program or data to the on-board device depending on biological information acquired by a biological information acquisition unit configured to acquire biological information of a person;
the on-board device, if the update program or data is received, stopping the execution of the program or data stored in the first storage region by the processing unit, and writing the received update program or data into the second storage region;
the on-board device restoring the execution of the program or data stored in the first storage region by the processing unit if the transmission of the update program or data is interrupted; and
the on-board device, after the writing of the update program or data into the second storage region is completed, changing a program or data to be executed by the processing unit from the program or data stored in the first storage region to the program or data stored in the second storage region.

15. The on-board update system according to claim 10, further comprising:
an authentication apparatus that includes the biological information acquisition unit, and is configured to perform an authentication process depending on the biological information acquired by the biological information acquisition unit; and
a door locking control apparatus that is configured to control the locking and unlocking of a door of the vehicle depending on the result of the authentication process performed by the authentication apparatus.
